(19) United States
(12) Patent Application Publication
(10) Pub. No.: US 2018/0211300 A1
(43) Pub. Date: Jul. 26, 2018

(54) SYSTEM AND METHOD FOR ASSESSING WAIT TIMES IN A FACILITY

(71) Applicant: Wal-Mart Stores, Inc., Bentonville, AR (US)

(72) Inventor: David G. Tovey, Rogers, AR (US)

(21) Appl. No.: 15/878,051

(22) Filed: Jan. 23, 2018

Related U.S. Application Data
(60) Provisional application No. 62/450,632, filed on Jan. 26, 2017.

(51) Int. Cl. G06Q 30/06; G06Q 90/00; G06K 9/00; G06K 9/78; G06T 7/70; G06T 7/62

(52) U.S. Cl. CPC G06Q 30/0613; G06Q 90/20; G06K 9/00362; G06K 9/00771; G06T 2207/30232; G06T 7/70; G06T 7/62; G06T 2207/30196; G06K 9/78

(57) ABSTRACT

Methods and systems for assessing wait times in a facility using imaging devices are discussed. The methods and systems can analyze images from the imaging devices to determine a waiting customer measurement, a cart fullness value, and a product category for at least one product in a cart, for each computing device in the facility. This information can be combined with personnel data to calculate a wait time for each computing device. Information related to mobile application usage may also be used to calculate wait times for the computing devices. The calculated wait times can be displayed on one or more displays in the facility.

### RELATED APPLICATIONS

This application claims priority to U.S. Provisional Patent Application No. 62/450,632, filed Jan. 26, 2017, the entire contents of which is incorporated herein by reference.

### BACKGROUND

Facilities frequently have multiple lanes through which individuals must pass when exiting the facility. Each of these lanes may have its own computing device at which transactions occur. These lanes may be viewable by one or more imaging devices disposed in the facility.

### BRIEF SUMMARY

In one embodiment, a system for assessing wait times in a facility includes one or more imaging devices and multiple computing devices. The system further includes a computing system equipped with a processor that is configured to execute an image analysis module and a mobile application determination module. The mobile application determination module, when executed, identifies a location of each individual equipped with an active mobile application associated with the facility in a line at each of the computing devices in the facility. The system also includes one or more displays. Execution of the image analysis module obtains at least one image from at least one of the one or more imaging devices and analyzes the image to determine a waiting customer measurement and a cart fullness value for each of the computing devices in the facility. Execution of the image analysis module retrieves, from the mobile application determination module, a mobile application usage determination for each waiting customer in a line at each of the plurality of computing devices. Execution of the image analysis module further calculates a wait time for each of the computing devices using the waiting customer measurement, the mobile application usage determination, and the cart fullness value. The calculated wait times for each of the computing devices are transmitted to the one or more displays.

In another embodiment, a computer-implemented method of assessing wait times in a facility includes identifying a location of each customer equipped with an active mobile application associated with the facility in a line at each of the plurality of computing devices in the facility. The computer-implemented method also includes obtaining at least one image from at least one of one or more imaging devices located in the facility and analyzing the image using a computing system equipped with a processor that is configured to execute an image analysis module to determine a waiting customer measurement and a cart fullness value for each computing device in the facility. The computer-implemented method also includes generating a mobile application determination for each customer in a line at each of the plurality of computing devices in the facility based on the identified location of the customer. The computer-implemented method also includes calculating, using the computing system, a wait time for each computing device using the waiting customer measurement, the cart fullness value, and the mobile application determination for each customer in line. The computer-implemented method also includes transmitting the calculated wait times for each of the computing devices to one or more displays.

### BRIEF DESCRIPTION OF DRAWINGS

To assist those of skill in the art in making and using the disclosed systems and methods for assessing wait times in a facility, reference is made to the accompanying figures. The accompanying figures, which are incorporated in and constitute a part of this specification, illustrate one or more embodiments of the invention and, together with the description, help to explain the invention. In the figures:

FIG. 1 illustrates an exemplary system for assessing wait times in a facility according to an exemplary embodiment.

FIG. 2A illustrates an exemplary method for assessing wait times in a facility according to an exemplary embodiment.

FIG. 2B illustrates an exemplary method for assessing wait times in a facility in an exemplary embodiment.

FIG. 3 illustrates an exemplary computing device suitable for use in an exemplary embodiment.

### DETAILED DESCRIPTION

Described in detail herein are methods and systems for assessing wait times in a facility using imaging devices. For example, embodiments can analyze images obtained using the imaging devices to determine a waiting customer measurement, a cart fullness value, and a product category for at least one product in a cart. This information can be combined with personnel data to calculate wait times for computing devices in a facility. In another embodiment, information related to mobile application usage by individuals in the facility may be used to calculate wait times for computing devices in the facility. The calculated wait times for the different computing devices can be displayed on one or more displays in the facility.

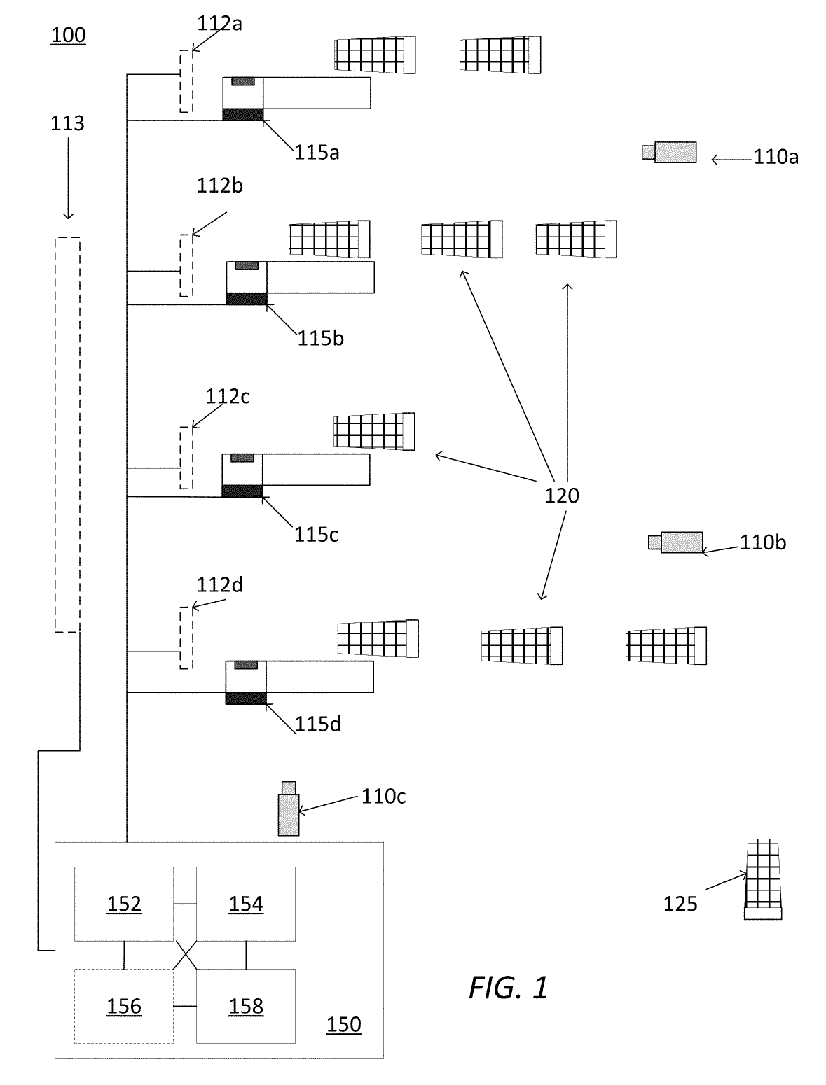

FIG. 1 illustrates an exemplary system 100 for assessing wait times in a facility. The system 100 can include imaging devices 110a-110c, computing devices 115a-115d, a computing system 150, and one or more displays 112a-112d, 113. The system 100 can obtain and analyze images of waiting customers 120 in line at the computing devices 115a-115d and their carts. The analyzed information can be combined with personnel information for individuals associated with the computing devices 115a-115d to aid in determining a wait time for each of computing devices 115a-115d. The wait time corresponding to each of the computing devices can be displayed on the one or more displays 112a-112d, 113 to guide an arriving customer 125 to a computing device with the shortest wait time.

The imaging devices 110a-110c can be positioned to view waiting customers 120 at all or a portion of the computing devices 115a-115d. In some embodiments, the imaging devices 110a-110c can be mounted at a vertically elevated location to point down at the waiting customers 120, such as by being mounted on a ceiling of the facility. It will be appreciated that in various embodiments, the number of imaging devices 110a-110c can be greater than, less than, or equal to the number of computing devices 115a-115d. The imaging devices 110a-110c can be any suitable imaging device configured to capture images as described herein and can acquire motion images (video) or still images. In some embodiments, the imaging devices 110a-110c can observe the waiting customers 120 from more than one angle. For example, as shown in FIG. 1, some imaging devices 110a, 110b can observe the waiting customers 120 from the rear while other imaging devices 110c can observe the waiting customers 120 from the side. In some embodiments, information obtained from images acquired from two different corrections can be cross-correlated by the image analysis module to improve accuracy. Although three imaging devices 110a-110c are shown in FIG. 1, it is contemplated that other numbers of imaging devices can be used to satisfy a particular application.

In one embodiment, the computing devices 115a-115d may be cash registers or other checkout devices and can each be associated with a location for customer checkout at a commercial retail facility. For example, each of the computing devices 115a-115d can be a point-of-sale terminal or cash register. In some embodiments, each computing device 115a-115d can be associated with an item conveyor. In one embodiment, computing devices 115a-115d can communicate with the computing system 150. In some embodiments, each computing device 115a-115d can transmit personnel data specific to an individual to the computing system 150. For example, the computing devices 115a-115d may transmit an identity of an individual logged in at each respective computing device to computing system 150. This information may be used to retrieve personnel data for that individual from a database that is used by the image analysis module in calculating wait times. Exemplary personnel data may include historical efficiency rates and/or a job title for the individual.

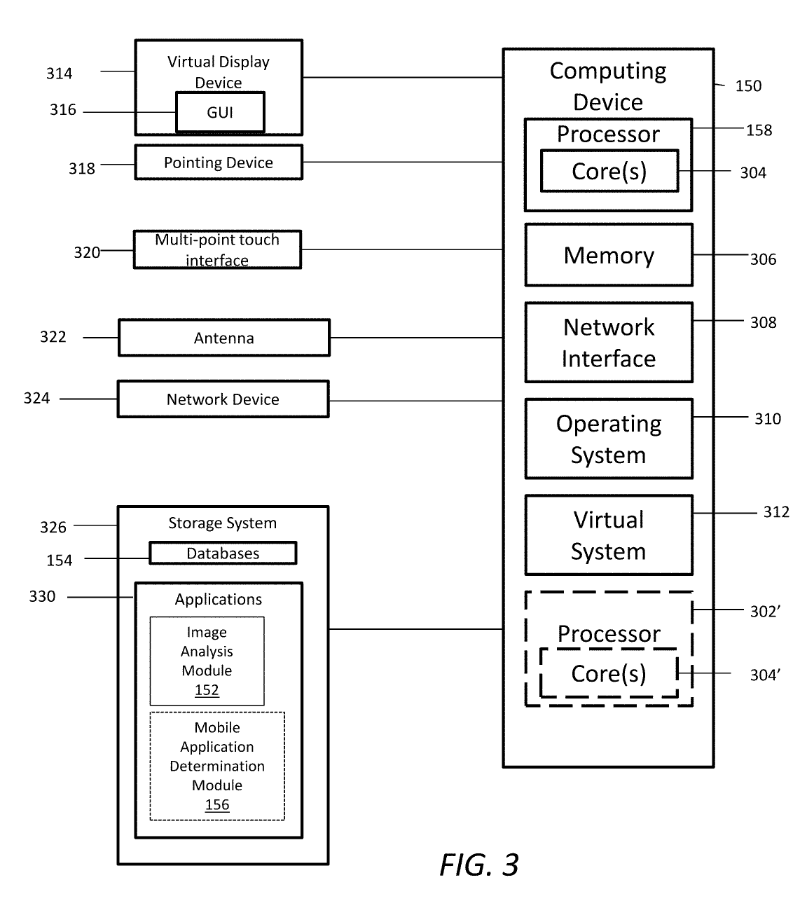

The computing system 150 can include a computing device equipped with a processor 158 configured to execute an image analysis module 152 and, optionally, a mobile application determination module 156. The computing device may be able to access a database 154 holding personnel data for individuals associated with respective computing devices 115a-115d, image information, and other data used by the image analysis module to calculate wait times. The computing system 150 may communicate with each of the computing devices 115a-115d and each of the one or more display devices 112a-112d, 113. An exemplary computing system 150 for use with the systems and methods described herein is illustrated in greater detail in FIG. 3.

In one embodiment, computing system 150 may execute the image analysis module 152 to assess wait times for each of the computing devices 115a-115d. In some embodiments, the image analysis module 152 can obtain at least one image originally captured by at least one of the imaging devices 110a-110c. Although the image analysis module 152 can obtain at least one image from at least one imaging device, it is contemplated that the image analysis module 152 can obtain more than one image from some or all of the imaging devices 115a-115d. In some embodiments, images from each of the imaging devices can be transmitted to the computing system 150 wirelessly or through a wired connection.

As discussed further below, image analysis module 152 can analyze the image to determine at least one of a waiting customer measurement, a cart fullness value, and a product category for at least one product in a customer's cart in an embodiment. Some of the properties of the analyzed image, such as the waiting customer measurement, can be determined for each of the computing devices 115a-115d. Some of the properties of the analyzed image, for example, the cart fullness value and product category, can be determined for each waiting customer 120 in line at each computing device 115a-115d. The image analysis module 152 can calculate a wait time for each of the computing devices using one or more of the waiting customer measurement, cart fullness value, product category or categories, and personnel data in the database 154 as well as a mobile application usage determination (described below).

In one embodiment, the waiting customer measurement is determined by the image analysis module analyzing data contained within one or more images captured by imaging devices in a facility. For example, the waiting customer measurement can be related to the number of customers waiting in a line at a computing device. In another embodiment, the waiting customer measurement may reflect the number of shopping carts in a line at a computing device. In a further embodiment, both the number of customers in the line and the number of carts in the line may be used in determining the waiting customer measurement. The image analysis module determines a value for the identified parameters (i.e. the number of carts/customers, etc.) based on pre-determined criteria. For example, the number of carts/customers in a line may lead to a time value being assigned based on past historical averages in the facility for the particular value. The determined waiting customer measurement may be combined with other values in the final calculation of a wait time for a computing device in the facility.

In one embodiment, the image analysis module 152 can analyze the image to determine the cart fullness value for shopping carts in a line at a computing device 115a-115d. The cart fullness value can be based upon one or more of the estimated filled volume of goods in the cart or a total or partial count of individual goods in the cart. In an embodiment, the cart fullness value can include a gross estimate of the number of items in the cart. The image analysis module can use the cart fullness value as a proxy measurement to estimate the time it will take for a given shopping cart to be processed by personnel at the computing device. For example, the image analysis module may assign a higher or lower value for a cart fullness value based on the assumption that a full cart may take longer to process through checkout than a relatively empty cart. In one embodiment, the actual value assigned may be based on historical data at the facility indicating how long full or partially filled carts take to empty. Such data may be retrieved by the image analysis module from the database. The determined cart fullness value may be combined with other values in the final calculation of a wait time for a computing device in the facility.

In an embodiment, the image analysis module 152 can determine a product category for at least one product in a customer's cart. In one embodiment, the image analysis module 152 can use object segmentation and recognition algorithms to process the image to identify individual objects or groups of objects. Different types of products in the cart can be assigned to a product category. Exemplary product categories can include, but are not limited to, general descriptors such as bulky items, items without a Universal Product Code (UPC), items requiring manual entry of product information, variable weight items, clothing, or any other suitable descriptors. In one embodiment, product categories can include specific descriptors such as product trade name or manufacturer name. The assortment of product categories present in a cart can affect the calculation of the wait time for the computing device 115a-115d for which the cart is waiting. Based on the analysis of product types present in the cart, the image analysis module may assign a time or other value as certain product categories may require extra actions be performed at the computing device. For example, a customer or store associate may have to weigh a variable weight product such as fresh produce, key in a code corresponding to the item for an item requiring manual entry of product information, or fold clothing and remove security tags or hangars. Each of these additional actions may increase the wait time at the computing device. As discussed previously, the actual value assigned based on product type may be based on historical data at the facility indicating how long certain types of products take to process at a computing device. Such data may be retrieved by the image analysis module from a database. In one embodiment, each type of product in the cart requiring additional processing may result in an adjustment in the value being assigned that is indicative of slower processing time. The determined value based on product type may be combined with other values in the final calculation of a wait time for a computing device in the facility.

In one embodiment, the image analysis module may retrieve personnel data from the database 154 as part of the calculation of the wait time for each of the computing devices 115a-115d. Personnel data can be associated with the individuals operating each of the computing devices. In one embodiment, the image analysis module communicates with the computing devices 115a-115d to determine an identity of the individual associated with the computing device. In another embodiment, the individual operating each of the computing devices 115a-115d can be identified by the image analysis module 152 examining one or more images. In one embodiment, personnel data can include historical efficiency data for the individual associated with each of the computing devices. For example, historical efficiency data can include measures of items or customers processed per unit of time. In an embodiment, personnel data can include position status or position title information for the individual associated with each of the computing devices. For example, position status or title information can include whether the individual is a manager and how long the individual has been employed at the company. The image analysis module may assign a time or other value based on the personnel information. For example, individuals that are more senior or that have been with the company longer may be able to process more items or customers per unit of time and therefore receive a value indicative of faster processing. The actual value assigned based on personnel data may be based on historical data at the facility indicating how long individuals with certain job titles take to process products at a computing device. Such data may be retrieved by the image analysis module from a database. The determined value based on personnel data may be combined with other values in the final calculation of a wait time for a computing device in the facility.

In one embodiment, the mobile application determination module 156 can identify waiting customers 120 that are using the mobile application to aid their shopping experience. For example, in one embodiment, the position of the device executing the mobile application may automatically be electronically determined to identify when an individual is in a line at a computing device in the facility. For example, Bluetooth-equipped devices located near (or integrated with) a computing device may interact with user devices of individuals in a line at the computing device that are executing the facility's mobile application to identify how many individuals in line are executing the facility's mobile application. In other embodiments, other location-based technologies may be used by the mobile application determination module to identify which individuals in line are executing the facility's mobile application. For example, the user device may be queried via a WiFi or other signal and triangulation may be used to determine a location from a response from the mobile application. In another embodiment, the mobile application may provide a location from the device's GPS to the mobile determination module. The image analysis module may assign a time or other value to the identified user when they get in line at a computing device on the basis that a user of the mobile application will be able to pay more quickly via an automatic method. For example, a user of a mobile application may be required or encouraged to enter payment information directly into the mobile application. The mobile application determination may result in a time or other value credit (indicative of faster processing) being assigned to a customer that may be combined with other values in the final calculation of a wait time for a computing device in the facility.

In an embodiment, the image analysis module takes input parameters (e.g. the determined waiting customer measurement, cart fullness value, and any adjustments for personnel data of individuals associated with the computing device, types of products in carts in line at the computing device and/or mobile application usage by customers in line) and calculates an overall wait time value for each computing device. It will be appreciated that other input parameters based on image data gathered from the image devices may be used in addition to, or in place of, the particular parameters discussed herein without departing from the scope of the present invention.

The one or more displays 112a-112d, 113 can display calculated wait times for some or all of the computing devices 115a-115d. In one embodiment, the one or more displays 112a-112d can identify inactive computing devices from among the computing devices 115a-115d. For example, in one embodiment, the displays can indicate which checkout lanes are closed. In one embodiment, the one or more displays can include an individual display 112a-112d associated with each of the computing devices 115a-115d. In an embodiment, the one or more displays can include a single central display 113 mounted centrally with respect to the computing devices 115a-115d. As a non-limiting example, the single central display 113 can have a viewing angle of greater than 150°. In one embodiment, one or more displays can be centrally located that are angled with respect to one another to increase visibility to arriving customers 125 at the far ends of the computing devices 115a-115d. In another embodiment, the one or more displays can include a first display and a second display that are positioned at opposite ends of an array of the computing devices 115a-115d.

In one embodiment, a visual assessment of arriving customer 125 activity is provided to other customers in the facility. The visual assessment can be useful to customers in the facility in determining where in the facility the concentration of customers is highest or enabling a quick assessment of where checkout activity is low and wait times are likely to be short. In some embodiments, the computing system 150 can use information obtained from the one or more imaging devices 110a-110c to identify the location of each arriving customer 125 and waiting customer 120 in the facility. For example, the view for each imaging device 110a-110c can be calibrated so that physical objects depicted in the view are mapped to a known location within the facility, and customer location can be determined by proximity to the physical objects. Alternatively, the location of the customer can be determining using triangulation in images acquired using imaging devices 110a-110c from different viewing angles. In some embodiments, a transponder associated with each shopping cart can aid the computing system 150 in identifying the location of arriving customers 125 and waiting customers 120. For example, the transponder can wirelessly report its location or can send signals that allow receivers within the facility to judge the distance from the transponder to the receivers and triangulate location.

In some embodiments, one or more displays 112a-112d, 113 can display the schematic view or map of the facility with indicators showing locations of the waiting customers 120 and/or arriving customers 125 in the facility. In some embodiments, the schematic view or map of the facility including customer indicators can be transmitted from the computing system 150 to a user device. The user device can be a portable electronic device mounted to the shopping cart in some embodiments. In other embodiments, the user device can be an application (or “app”) that resides in a memory of a mobile communications device such as a smartphone being operated by the user. In some embodiments, the computing system 150 can also transmit the wait times for the computing devices 115a-115d to the user device.

In some embodiments, the computing system 150 can provide the user device with a predictive wait time for the particular customer associated with the user device. For example, the computing system 150 can determine the location of the user device within the facility and can determine a proximity of the user device to the computing devices 115a-115d. The computing system 150 can also assess the cart fullness of the shopping cart using the cart fullness module as described above. The computing system 150 can use the proximity of the user device, the cart fullness, and the calculated wait times to determine an expected time for the customer to complete check-out including transit times to the computing devices 115a-115d. In some embodiments, the expected time for the customer to complete check-out can be transmitted from the computing system 150 to the user device.

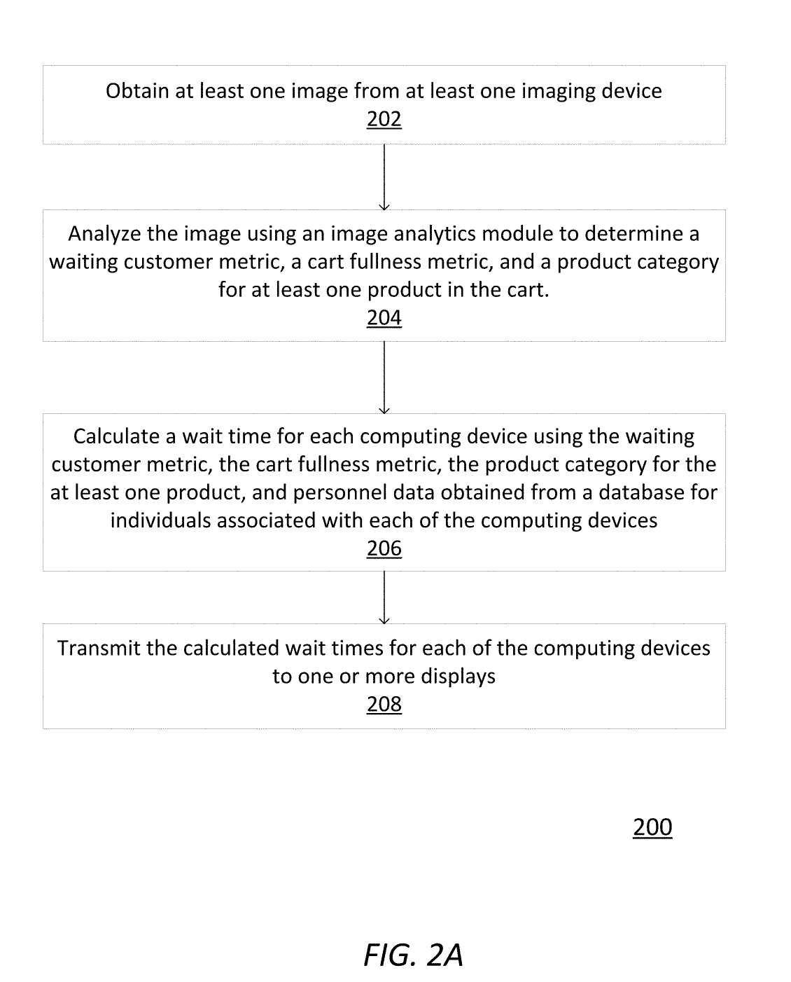

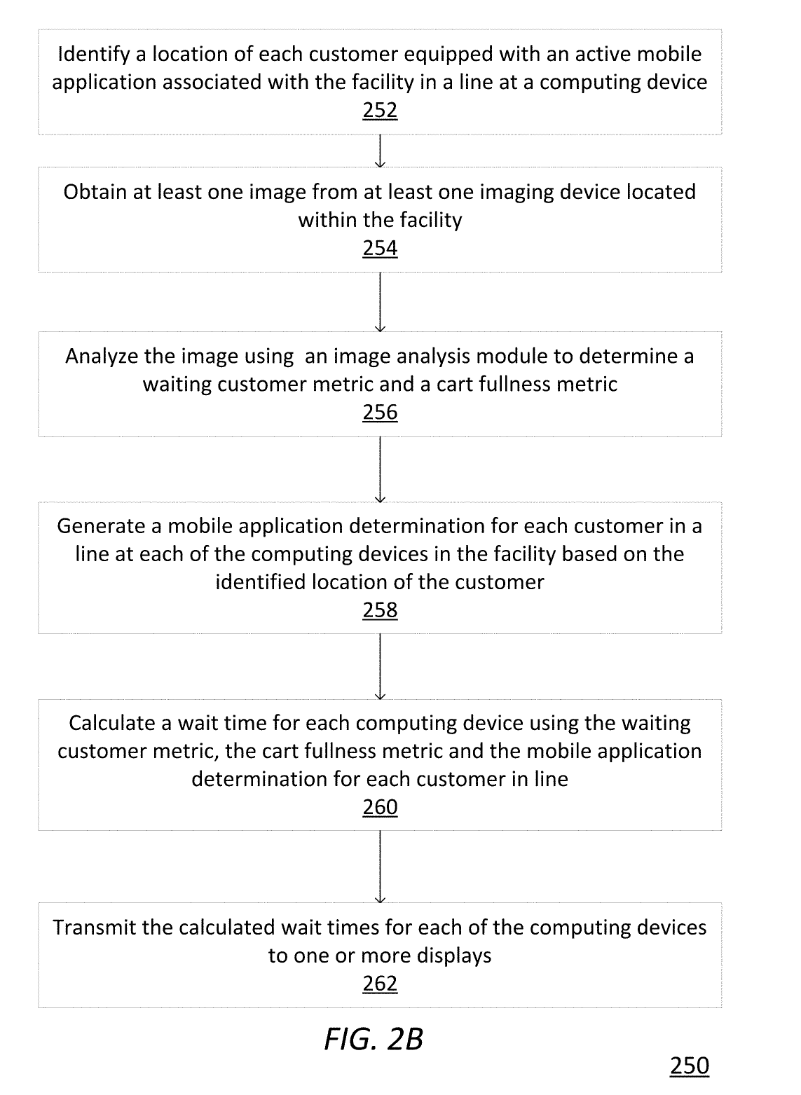

FIG. 2A illustrates an exemplary method 200 of assessing wait times in a facility in an exemplary embodiment. It will be appreciated that the method is programmatically performed by one or more computer-executable processes executing on, or in communication with, one or more computing devices equipped with processor(s) as described further below. The exemplary method 200 begins by obtaining at least one image from at least one of the imaging devices (step 202). Obtaining the at least one image can include, but is not limited to, accessing one or more imaging devices 110a-110c using computing system 150 as described above with reference to FIG. 1. Alternatively, the imaging devices may automatically transmit the images to computing system 150 or another device for storage until they can be analyzed.

The method 200 also analyzes the at least one image to determine a waiting customer measurement, a cart fullness value, and, a product category for at least one product in a cart in line at a computing device (step 204). In some embodiments, the image analysis can be performed using the computing system 150 and image analysis module 152 as described above with reference to FIG. 1. The method 200 further calculates, using the computing system, a wait time for each computing device using the waiting customer measurement, the cart fullness value, the product category for at least one product, and personnel data obtained from a database for individuals associated with each of the computing devices (step 506). For example, the computing system 150 can calculate a wait time for each of the computing devices 115a-115d as described above with reference to FIG. 1.

The method 200 also transmits the calculated wait times for each of the computing devices to one or more displays (step 208). For example, the one or more displays can include the displays 112a-112d, 113 described above with reference to FIG. 1.

FIG. 2B illustrates an exemplary method 500 of assessing wait times in a facility in an exemplary embodiment. It will be appreciated that the method is programmatically performed by one or more computer-executable processes executing on, or in communication with, one or more computing devices equipped with processor(s) as described further below. The method begins by identifying a location of each customer equipped with an active mobile application associated with the facility that is in a line at each computing device in the facility (step 252). At least one image is obtained from imaging devices disposed in the facility (step 254). The image analysis module analyzes the image to determine a waiting customer measurement and a cart fullness value (step 256). A mobile application determination is generated for each customer in each line at each of the computing devices based on the customer's identified location (step 258). For example, the mobile application determination module may identify the locations of the customers in lines at computing devices in the facility and the image analysis module may cross reference the location data with image data to determine how many customers in line at a given computing device are using a mobile application (e.g. the mobile application determination module may identify three customers in a line at a computing device using mobile applications and the image analysis module may identify six total customers in line). The image analysis module then calculates a wait time for each computing device using the waiting customer measurement, the cart fullness value, and a mobile application determination for each customer in line at that computing device (step 260). The use of the mobile application determination enables the image analysis module to estimate how many customers in a line will save time by paying with the mobile application and incorporates this finding into the calculated wait time for a computing device. The calculated wait times for each computing device are transmitted to one or more displays in the facility for presentation to the customers (step 262).

FIG. 3 is a block diagram of an example computing system 150 for implementing exemplary embodiments of the present disclosure. Embodiments of the computing system 150 can execute the image analysis module 152 and, optionally, the mobile application determination module 156. The computing system 150 can include one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing system 150 may store computer-readable and computer-executable instructions or software (e.g., code or applications 330 such as the image analysis module 152 or mobile application determination module 156) for implementing exemplary operations of the computing system 150. The computing system 150 also includes configurable and/or programmable processor 158 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing system 150.

Virtualization may be employed in the computing system 150 so that infrastructure and resources in the computing system 150 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing system 150 through a visual display device 314, such as a computer monitor, which may display one or more graphical user interfaces 316, multi touch interface 320 and a pointing device 318.

The computing system 150 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 154 for storing information regarding the sounds produced by actions taking place in a facility, sound signatures, and sound patterns. The databases 328 may be updated manually or automatically at any suitable time to add, delete, and/or update one or more data items in the databases.

The computing system 150 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing system 150 and a network and/or between the computing system 150 and other computing devices. The network interface 308 may include a built-in network adapter, network interface card, PCMCIA network card, card bus network adapter, wireless network adapter, USB network adapter, modem or any other device suitable for interfacing the computing system 150 to any type of network capable of communication and performing the operations described herein. In some embodiments, the computing system 150 can communicate with the one or more computing devices 115a-115d through the network.

The computing system 150 may run operating systems 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating system capable of running on the computing system 150 and performing the operations described herein. In exemplary embodiments, the operating system 310 may be run in native mode or emulated mode. In an exemplary embodiment, the operating system 310 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes system elements, device components, or method steps, those elements, components, or steps may be replaced with a single element, component, or step. Likewise, a single element, component, or step may be replaced with multiple elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for assessing wait times in a facility comprising:
one or more imaging devices;
a plurality of computing devices;
a computing system equipped with a processor and configured to execute an image analysis module and a mobile application determination module; and
one or more displays;
wherein the mobile application determination module when executed identifies a location of each individual equipped with an active mobile application associated with the facility in a line at each of the plurality of computing devices, and
wherein execution of the image analysis module:
obtains at least one image from at least one of the one or more imaging devices;
analyzes the image to determine a waiting customer measurement and a cart fullness value for each of the plurality of computing devices;
retrieves, from the mobile application determination module, a mobile application usage determination for each waiting customer in a line at each of the plurality of computing devices;
calculates a wait time for each of the computing devices using the waiting customer measurement, the mobile application usage determination, and the cart fullness value; and
transmits the calculated wait times for each of the plurality of computing devices to the one or more displays.

2. The system of claim 1, further comprising:
a database including personnel data for individuals associated with each of the plurality of computing devices, the computing system communicatively coupled to the database, and
wherein execution of the image analysis module to calculate a wait time for each of the computing devices further includes using the personnel data in the database.

3. The system of claim 1, wherein execution of the image module to analyze the image further includes determining, for at least one product in the cart, a product category, and
wherein execution of the image module to calculate a wait time for each of the computing devices further includes using the product category for the at least one product in the cart.

4. The system of claim 3, wherein the product category is for a type of item in a category requiring manual entry of product information at one of the plurality of computing devices.

5. The system of claim 1, wherein the one or more displays includes a single display mounted centrally with respect to the plurality of computing devices.

6. The system of claim 5, wherein the single display has a viewing angle of greater than 150°.

7. The system of claim 1, wherein the one or more displays includes a first display and a second display that are positioned at opposite ends of an array of the plurality of computing devices.

8. The system of claim 1, wherein the one or more displays identify inactive computing devices among the plurality of computing devices.

9. The system of claim 2, wherein the personnel data includes historical efficiency data for the individual associated with each of the plurality of computing devices.

10. The system of claim 2, wherein the personnel data includes position status or position title information for the individual associated with each of the plurality of computing devices.

11. The system of claim 1, wherein the cart fullness value is determined by estimating a filled volume of a cart or a total count of items within the cart.

12. The system of claim 1, wherein the computing system is configured to display a schematic of the facility including indicators showing locations of waiting and arriving customers in the facility on the one or more displays.

13. A computer-implemented method of assessing wait times in a facility comprising:
identifying a location of each customer equipped with an active mobile application associated with the facility in a line at each of the plurality of computing devices in the facility;
obtaining at least one image from at least one of one or more imaging devices located in the facility;
analyzing the image using a computing system equipped with a processor and configured to execute an image analysis module to determine a waiting customer measurement, and a cart fullness value for each of a plurality of computing devices in the facility;
generating a mobile application determination for each customer in a line at each of the plurality of computing devices in the facility based on the identified location of the customer;
calculating, using the computing system, a wait time for each computing device of the plurality of computing devices using the waiting customer measurement, the cart fullness value and the mobile application determination for each customer in line;
transmitting the calculated wait times for each of the plurality of computing devices to one or more displays.

14. The computer-implemented method of claim 13, wherein analyzing the image using the computer system equipped with the processor and configured to execute the image analysis module further determines, for at least one product in a cart, a product category, and
wherein calculating, using the computing system, the wait time for each computing device further comprises using the product category for the at least one product.

15. The computer-implemented method of claim 13, wherein calculating, using the computing system, the wait time for each computing device further comprises using personnel data obtained from a database for individuals associated with each of the plurality of computing devices.

16. The computer-implemented method of claim 13, wherein analyzing the image to determine the cart fullness value includes estimating a filled volume of a cart or a total count of items within the cart.

17. The computer-implemented method of claim 13, further comprising displaying a schematic of the facility including indicators showing locations of waiting and arriving customers in the facility on the one or more displays.

18. The computer-implemented method of claim 15, wherein the personnel data used in calculating the wait time for each computing device includes position status or position title information for the individual associated with each of the plurality of computing devices.

19. The computer-implemented method of claim 15, wherein the personnel data used in calculating the wait time for each computing device includes historical efficiency data for the individual associated with each of the plurality of computing devices.
